(19) United States
(12) Patent Application Publication
(10) Pub. No.: US 2013/0285357 A1
(43) Pub. Date: Oct. 31, 2013

(54) PASSIVE ROLL-OVER PROTECTION SYSTEM FOR A LAWN VEHICLE

(71) Applicant: MTD PRODUCTS INC, Valley City, OH (US)

(72) Inventor: Jimmy N. Eavenson, SR., Aurora, OH (US)

(73) Assignee: MTD Products Inc., Valley City, OH (US)

(21) Appl. No.: 13/869,417

(22) Filed: Apr. 24, 2013

Related U.S. Application Data
(60) Provisional application No. 61/638,261, filed on Apr. 25, 2012.

(51) Int. Cl. B60R 21/13

(52) U.S. Cl. CPC B60R 21/131
USPC 280/756

(57) ABSTRACT

A lawn vehicle having a passive roll-over protection system attached thereto is provided. The roll-over protection system includes an elongated roll-bar that extends rearwardly at an angle from the frame of the lawn vehicle. The roll-bar is a generally U-shaped tubular member in which opposing distal ends of the roll-bar are operatively connected to the frame of the lawn vehicle. The system also includes a support member that provides lateral support to the roll-bar. The support member is operatively connected to the roll-bar and extends laterally from the roll-bar to the frame of the lawn vehicle for distributing the weight and forces experienced by the roll-bar.

### FIELD OF THE INVENTION

The present invention is directed to a protection system, and more particularly, to a roll-over protection system for a lawn vehicle that does not require operator involvement.

### BACKGROUND OF THE INVENTION

During the course of using a lawn vehicle, such as a lawn mower, lawn tractor, or lawn utility vehicle, unexpected obstacles or events may happen that would cause the lawn vehicle to tip to one side or the other, roll mostly or completely over, or tip rearwardly that puts the operator into a dangerous situation in which the operator can potentially be caught in the engine, controls, or the blades of the vehicle. It has been found that restraint or protective systems that require operator involvement or operation are often ineffective due to lack of operator use or action. For example, safety belts have been included on riding lawn mowers, but if the operator does not buckle the safety belt, the safety belt becomes ineffective at preventing injury or death during a roll-over or tipping event.

Accordingly, there is a need for a roll-over protection system that does not require operator action or actuation such that the protection system prevents or reduces the likelihood of operator injury during roll-over events without the need for operator involvement.

### BRIEF SUMMARY OF THE INVENTION

According to one aspect of the present invention, a passive roll-over protection system is provided. The passive roll-over protection system is operatively connected to a frame of a lawn vehicle. The passive roll-over protection system, includes a roll-bar attached to said frame of the lawn vehicle, wherein the roll-bar extends from the frame at an angle relative to the frame. A support member is operatively connected to the roll-bar and the frame of the lawn vehicle for providing lateral support to the roll-bar.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1 is an exemplary embodiment of a lawn vehicle having a passive roll-over protection system attached thereto.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

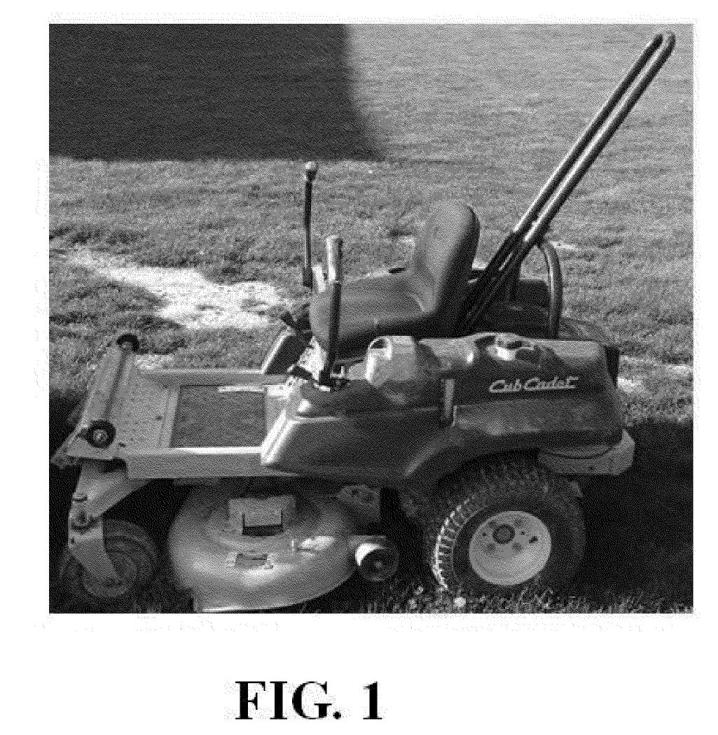

Referring to FIG. 1, an embodiment of a lawn vehicle having a passive roll-over protection system is shown. The lawn vehicle of the illustrated embodiment is a zero-turn radius lawn mower. The passive roll-over protection system includes an elongated roll-bar that is attached to the frame of the lawn vehicle, and the roll-bar extends rearwardly at an angle behind the seat for the operator. The roll-bar extends at an angle of about 60° relative to the horizontal plane of the lawn vehicle, but it should be understood by one of ordinary skill in the art that the roll-bar can extend from the frame at an angle of between about 30° to about 90° relative to the horizontal plane of the lawn vehicle. In an embodiment, passive roll-over protection system may also include a cover such as a flexible foam positioned over a portion of the roll-bar to assist in dampening the contact between the roll-bar and the ground. In an embodiment, the roll-bar does not extend vertically above the height of the top of the head of an average operator when in a seated position on the lawn vehicle. The roll-bar is positioned out of the line-of-view of the operator as the operator is operating the lawn vehicle so as to not interfere with the view of the operator.

The passive roll-over protection system further includes a support member that is operatively connected to the roll-bar and the frame of the lawn vehicle. The support member provides lateral support to the roll bar as well as distributes the forces and loads encountered by the roll bar during a roll-over event. The support member can be attached to the roll-bar by welding or a mechanical fastening mechanism such as a nut-and-bolt or the like. A nut-and-bolt fastening mechanism allows the roll-bar and/or the support mechanism to be disassembled for repair or repair or replacement subsequent to a roll-over event.

In an embodiment, the roll-over bar and the support member are formed as tubular structures so as to reduce the weight of the passive roll-over protection system and additional to prevent a detrimental shifting of the center of gravity of the lawn vehicle which may result in a higher likelihood of a roll-over event.

In operation, if the lawn vehicle tips backward such that the front wheels lose contact with the ground and the lawn vehicle rotates about the rear axle, the passive roll-over protection system is the first member that contacts the ground. In a rear-tipping event, the roll-bar contacts the ground and acts similar to a kickstand on a bicycle by forming a stable triangular structure between the lawn vehicle rear axle/frame, the ground, and the roll-bar. Unless there is forward momentum or a shift in weight on the lawn vehicle, the roll-bar will maintain the lawn vehicle in a tipped position. If the operator becomes disengaged with the seat such that the operator falls off the lawn vehicle, the roll-bar is angled relative to the frame of the lawn vehicle to push or slide the operator away from the lawn vehicle, thereby preventing further injury.

The passive roll-over protection system provides a rigid structure to limit and/or prevent roll-overs while providing clear space between the machine and the terrain. This lessons the possibility for entrapment of the user between the lawn vehicle and the ground. The narrow spacing of the structural tubing of the roll-bar prevents operator access, and the angular orientation of the roll-bar relative to the lawn vehicle frame prevents operator contact with the functioning components, such as engine, traction drive, exhaust, and the like, while the operator is guided away from the machine by the roll-bar during a roll-over or tipping event. The structure can easily limit/prevent longitudinal tip-overs by functioning in the same manner as a bicycle kick-stand. For lateral events, the structure typically reduces a potential roll-over (180 degrees or more) to a tip-over (less than 180 degrees).

The passive roll-over protection system is configured to limit or prevent rearward tip-overs and lateral roll-overs. The configuration of the passive roll-over protection system prevents operator injuries resulting from contact with the structure or other parts of the machine. The height and shape of the passive roll-over protection system is un-obtrusive and negates any need for folding. In the event of a rearward tip-over, the passive roll-over protection system guides the operator away from the machine.

The passive roll-over protection system does not impede operation of the machine. In low speed sideways roll-overs, the passive roll-over protection system limited the roll-over and prevents entrapment of the operator. The passive roll-over protection system provides clearance between the ground and the machine to reduce possible operator entrapment. In rearward tip-over tests, the passive roll-over protection system limited the rearward tip-over, and the machine typically pivoted to one side, away from the operator. The passive roll-over protection system is effective in reducing the likelihood of crush-injuries to operators during lightweight machine lateral roll-over and rearward tip-over events.

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A passive roll-over protection system operatively connected to a frame of a lawn vehicle, said passive roll-over protection system comprising:
a roll-bar attached to said frame of said lawn vehicle, wherein said roll-bar extends from said frame at an angle relative to said frame;
a support member operatively connected to said roll-bar and said frame of said lawn vehicle for providing lateral support to said roll-bar.

2. The passive roll-over protection system of claim 1, wherein said roll-bar and said support member are tubular.
